(19) United States
(12) Patent Application Publication
(10) Pub. No.: US 2022/0351311 A1
(43) Pub. Date: Nov. 3, 2022

(54) SYSTEMS AND METHODS TO PERFORM A COST SEGREGATION STUDY OF A REAL PROPERTY ASSET

(71) Applicant: Engineered Tax Services, Inc., West Palm Beach, FL (US)

(72) Inventors: Nicholas MACSANDERS, Tacoma, WA (US); Cody DUFOUR, Plan, TX (US)

(21) Appl. No.: 17/246,075

(22) Filed: Apr. 30, 2021

(51) Int. Cl. G06Q 50/16; G06Q 30/02

(52) U.S. Cl. CPC G06Q 50/16; G06Q 30/0201

(57) ABSTRACT

Systems and methods to perform a cost segregation study are provided. The method includes receiving a request to perform a cost segregation study of a real property asset, determining, based on a set of characteristics of the real property asset, an initial cost segregation template for the real property asset. The method also includes receiving one or more updates to one or more of the plurality of components of the real property asset, and updating, in response to receiving the one or more updates, the plurality of components by the one or more updates to include components actually included in the real property asset. The method further includes determining, based on a set of criteria, one or more cost segregation rules applicable to the plurality of components, and applying the one or more cost segregation rules to determine cost segregation of the real property asset.

### BACKGROUND

The present disclosure relates generally to systems and methods to perform a cost segregation study of a real property asset.

Cost segregation studies are sometimes performed to identify personal property assets that are grouped with real property assets, and separating out personal property assets for tax reporting purposes. In some embodiments, a cost segregation study is performed to determine certain components of a real property, such as, but not limited to, lighting, carpet, wall covering, toiletry, and other non-structural components that have shorter tax lives relative to the tax life of the real property. In some embodiments, the cost segregation study is utilized to determine potential tax savings on a real property asset as a result of reducing the tax life of certain identified components relative to the tax life of the real property asset. However, different real property assets have different components that are eligible for cost segregation.

### BRIEF DESCRIPTION OF THE DRAWINGS

Illustrative embodiments of the present invention are described in detail below with reference to the attached drawing Figures, which are incorporated by reference herein, and wherein:

FIG. 1 is a network environment for performing a cost segregation study in accordance with one embodiment.

FIG. 2 is a tree diagram illustrating a process to determine applicable cost segregation rules in accordance with one embodiment.

FIG. 3 is a system diagram of the cost segregation system of FIG. 1 in accordance with one embodiment.

FIG. 4 is a flowchart of a process to perform a cost segregation study in accordance with one embodiment.

FIG. 5 is a flowchart of another process to perform a cost segregation study in accordance with one embodiment.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to systems and methods to perform a cost segregation study of a real property asset. An electronic device of a user seeking to obtain a cost segregation study of a real property asset, such as, but not limited to, an apartment complex, a shopping mall, an office building, an industrial building, a stadium, a parking structure, a ranch, or another type of real property asset, transmits a request to perform a cost segregation study on the real property asset to a cost segregation system described herein. The cost segregation system determines, based on a set of characteristics of the real property asset, an initial cost segregation template for the real property asset. As referred to herein, an initial cost segregation template for a particular real property asset is a template containing components that qualify for cost segregation and are initially or predetermined to be included in the real property asset. Further, as referred to herein, a component of real property asset that qualifies for cost segregation refers to any building component, structure component, or improvement that qualifies for an accelerated depreciation relative to the deprecation of the underlying real property asset. Example of components that qualify for cost segregation include, but are not limited to, electrical components, lighting, telecommunications, heating and cooling systems, toiletry, cabinets, moldings, landscaping, as well as other building components, improvements, and building structures of the real property asset.

In some embodiments, the initial cost segregation template is based on prior cost segregation studies performed on similar real property assets. For example, where the user requests a cost segregation study on a 10-unit apartment complex within a subdivision, an initial cost segregation template of a 12-unit apartment complex located in the same subdivision is utilized. In some embodiments, the cost segregation template further customizes an initial cost segregation template based on additional information regarding the real property asset initially provided by the user. For example, where the user also indicates that each unit of the 10-unit apartment complex has one central air system and two toilets, the cost segregation system customized the initial cost segregation template of the 10-unit apartment complex to include 10 central air systems and 20 toilets. In some embodiments, the initial cost segregation template also prompts the user with a series of questions regarding the real property asset, such as, but not limited to, the type of the real property asset, the location of the real property asset, the age of the real property assets, dimensions of the real property asset, improvements made to the real property asset, existing components of the real property asset, number of units of property of the real property asset, as well as other questions regarding the real property asset that facilitates the cost segregation system to determine an initial cost segregation template for the real property asset.

In some embodiments, the cost segregation system, after determining the initial cost segregation template of the real property asset, provides the initial cost segregation template for display on the user's electronic device. In one or more of such embodiments, the cost segregation system provides the user with customization options to further customize the initial cost segregation template to accurately reflect the components of the real property asset. Continuing with the foregoing example where the cost segregation system provides the user with an initial cost segregation template of a 10-unit apartment complex, the cost segregation system also provides the user with additional customization options to tailor the initial cost segregation template to include components of the 10-unit apartment complex. For example, where one unit of the 10-unit apartment complex has specialty plumbing, and two units of the 10-unit apartment complex have ceiling speakers, the cost segregation system allows the user to customize and update the initial cost segregation template to include specialty plumbing, ceiling speakers, and other components not initially included in the initial cost segregation template. In some embodiments, the cost segregation system also dynamically updates the initial cost segregation template based on customizations made by the user and stores updates to the initial cost segregation template for future use. Similarly, in some embodiments, the cost segregation system also dynamically learns which questions to prompt the user when generating the initial cost segregation template, and when determining whether to update the initial cost segregation template to include components actually included in the real property asset. For example, the cost segregation system, in response to determining that three previous users (or a different threshold number of users) who requested cost segregation studies on shopping malls subsequently indicated that the shopping malls have escalators, determines to initially prompt future users seeking cost segregation studies on shopping malls with one or more questions regarding the presence and condition of escalators. Additional descriptions of operations performed by the cost segregation system to determine an initial cost segregation template, and to update the cost segregation template with components actually included in the real property asset are provided in the paragraphs below.

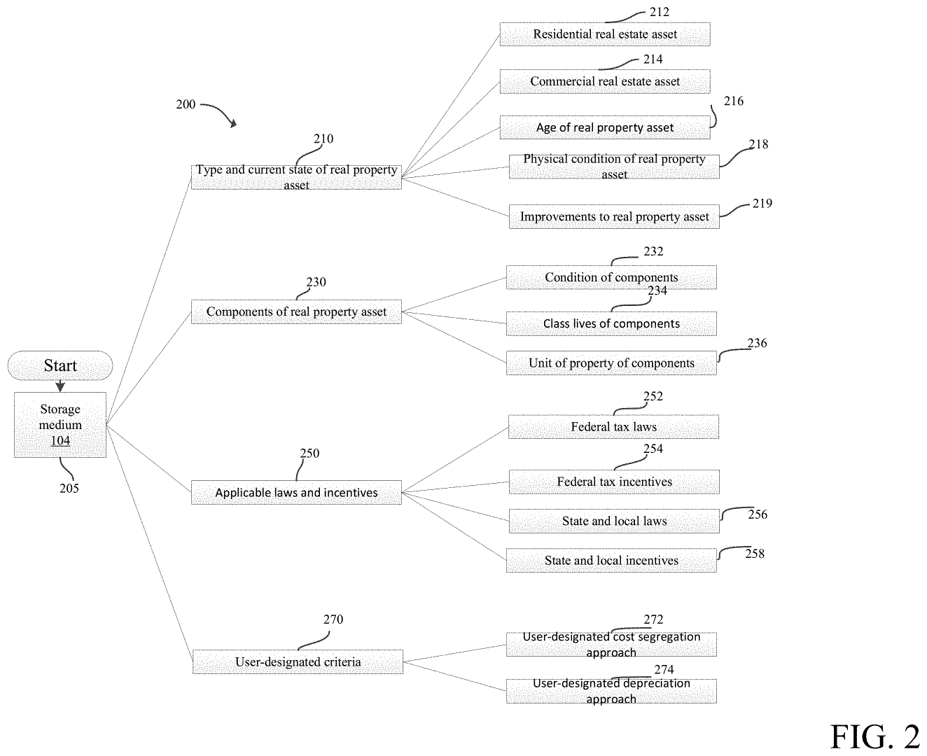

The cost segregation system, after determining the components of the real property asset, also determines, based on a set of criteria, applicable cost segregation rules for performing the cost segregation study. Examples of criteria for determining applicable cost segregation rules include, but are not limited to, the type of the real property asset, the current state of the real property asset, components of the real property asset, applicable laws and incentives, and user-designated criteria. For example, where the real property asset is a stadium located in Arlington, Tex., the cost segregation system determines applicable federal, state, and local tax laws and incentives on cost segregation of a stadium. Similarly, where the user designates a certain cost segregation formula to be used on certain types of components, the user-designated criteria are applied by the cost segregation system. Additional descriptions of operations performed by the cost segregation system to determine applicable cost segregation rules are provided in the paragraphs below and are illustrated in at least FIG. 2.

The cost segregation system then applies the rules to determine cost segregation of the real property asset. In some embodiments, the cost segregation system applies all of the applicable rules to determine cost segregation of the real property asset. In some embodiments, the cost segregation system applies certain rules based on a weighted system. For example, rules based on federal, state, and local tax laws are always given the highest weight and are always applied, whereas rules based on user-designated criteria are given the next highest set of weights and are always applied provided that they do not contradict federal, state, or local tax laws.

In some embodiments, the cost segregation system generates a report (such as an engineering report or another type of report) of the cost segregation of the real property asset, and provides the generated engineering report for display on the user's electronic device. In some embodiments, the cost segregation system generates sub-reports within the engineering report. For example, where the cost segregation system classifies components of the real property asset into multiple classes, the cost segregation system also generates a sub-report for each class of the multiple classes. Similarly, where the real property asset contains different unit of properties, the cost segregation system determines the number of unit of properties of the real property asset, generates a separate sub-report for each unit of property, and provides the generated sub-reports to the user for comparison and analysis. In some embodiments, where the user seeks to obtain cost segregation of the real property based on different depreciation methods, the cost segregation system applies different sets of rules that define cost segregation based on the different metrics (e.g., applying a partial asset disposition method vs. applying repair & maintenance method vs. using normal real property depreciation) to generate a separate sub-report of each depreciation method, and provides the generated sub-reports to the user for comparison and further analysis.

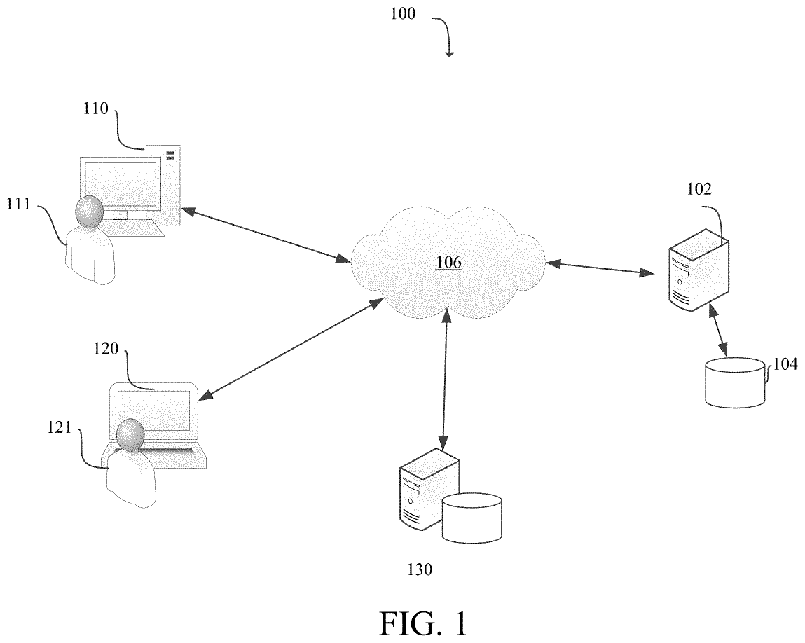

In some embodiments, where multiple users are simultaneously working to perform a cost segregation study on the same real property asset, the cost segregation system is configured to simultaneously and dynamically receive instructions and updates from each user. For example, the cost segregation system is configured to allow multiple users to simultaneously update different components of the real property asset to reduce the overall amount of time spent to perform the cost segregation study. Similarly, the cost segregation system is also configured to allow multiple users to simultaneously run different cost segregation studies, such as based on different depreciation methods, to generate different engineering reports of the cost segregation of the real property asset. Additional descriptions of the cost segregation system and operations performed by the cost segregation system are provided in the paragraphs below and are illustrated in at least FIGS. 1-4.

FIG. 1 is a network environment 100 for performing a cost segregation study in accordance with one embodiment. Network environment 100 includes a cost segregation system 102 that is communicatively connected to a first electronic device 110 that is operated by user 111, a second electronic device 120 that is operated by user 121, and a third-party system 130 via a network 106.

First electronic device 110 and second electronic device 120 include any devices that are operable to request a cost segregation system, such as cost segregation system 102, to perform a cost segregation study of a real property asset, and request cost segregation system 102 to update components of the real property asset. In the embodiment of FIG. 1, first electronic device 110 is a desktop computer whereas second electronic device 120 is a laptop computer. Additional examples of electronic devices include, but are not limited to, tablet computers, smartphones, smart watches, PDAs, as well as similar electronic devices having a processor operable to request a cost segregation system, such as cost segregation system 102, to perform a cost segregation study of a real property asset, and request cost segregation system 102 to update components of the real property asset.

In the embodiment of FIG. 1, first electronic device 110 transmits a request to cost segregation system 102 to perform a cost segregation study of a real property asset. In some embodiments, first electronic device 110 also transmits data indicative of information regarding the real property asset to cost segregation system 102.

Cost segregation system 102 may be formed from one or more work management stations, server systems, desktop computers, laptop computers, tablet computers, smartphones, smart watches, PDAs, as well as similar electronic devices having one or more processors operable to receive a request to perform a cost segregation study, determine an initial cost segregation template, update the initial cost segregation template with components of the real property asset, determine applicable cost segregation rules, and apply the cost segregation rules to determine cost segregation of the real property asset. Additional descriptions of operations performed by cost segregation system 102 are provided herein and are illustrated in at least FIGS. 2-4. Cost segregation system 102 includes or is communicatively connected to a storage medium, such as storage medium 104. Storage medium 104 stores instructions which, when executed by one or more processors of cost segregation system 102, cause the processors to perform the foregoing operations as well as other operations described herein.

Storage medium 104 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, storage medium 104 includes multiple data storage devices. In further embodiments, the multiple data storage devices may be physically stored at different locations. In one of such embodiments, the data storage devices are components of a server station, such as a cloud server. In another one of such embodiments, the data storage devices are components of cost segregation system 102. Storage medium 104, in addition to storing executable instructions, also stores information provided by first electronic device 110, second electronic device 120, and by other third-party systems, such as information regarding a real property asset of interest, prior cost segregation operations performed on the real property assets including the real property asset of interest, current federal, state, and local tax laws and incentives on cost segregation and depreciation methods, initial cost segregation templates of the real property asset of interest, blueprints of the real property asset of interest, improvements made on the real property asset of interest, as well as data associated with cost segregation studies performed by or utilized by cost segregation system (collectively referred to as “cost segregation study data”).

Cost segregation system 102 is also communicatively connected to one or more third-party systems or networks. Examples of third-party systems include, but are not limited to, systems and networks of tax agencies such as the Internal Revenue Services, systems and networks of accounting firms, systems and networks that store information regarding technical drawings of the real property asset of interest, components of the real property asset of interest, as well as other third-party systems and networks operable to provide cost segregation study data to cost segregation system 102. In the depicted embodiment, the third-party systems and networks are collectively illustrated as third-party system 130. In some embodiments, the third-party system 130 provides cost segregation system 102 with up-to-date cost segregation study data cost segregation system 102 utilizes to determine the characteristics of the real property asset of interest, update components of the real property asset of interest, and determine applicable cost segregation rules.

In the embodiment of FIG. 1, cost segregation system 102, upon receipt of a request to perform a cost segregation study on a real property asset of interest, accesses storage medium 104 and/or third-party system 130 to obtain cost segregation study data of the real property asset of interest, and determines, based on the characteristics of the real property asset of interest initially provided by first electronic device 110, or obtained from storage medium 104 or third-party system 130, an initial cost segregation template for the real property asset of interest. For example, where cost segregation system 102 receives a request from first electronic device 110 to perform a cost segregation study of a five-story office building together with the address of the five-story office building, cost segregation system 102 accesses storage medium 104 and third-party system 130 to obtain the age of the five-story office building, blueprints of the five-story office building, improvements made to the five-story office building, known components of the five-story office building that qualify for cost segregation, cost segregation studies previously performed on the five-story office building, pre-existing cost segregation templates on the five-story office building or similar real property assets, and other relevant cost segregation study data. Cost segregation system 102 analyzes the obtained cost segregation study data, determines characteristics of the real property asset of interest, generates an initial cost segregation template for the real property asset of interest, and provides the initial cost segregation template for display on first electronic device 110. Continuing with the foregoing example, where user 111 initially requested a cost segregation study on a five-story office building, cost segregation system 102 obtains cost segregation study data of the five-story office building (for example the location of the building, the blueprint of the building, the age of the building, improvements made to the building, known information regarding different unit of property of the building, known information regarding different components of the building), generates an initial cost segregation template of the five-story office building, and provides the generated initial cost segregation template for display on electronic device 110.

In one or more of such embodiments, cost segregation system 102, in response to receiving a request from first electronic device 110 to perform a cost segregation study, dynamically requests first electronic device 110 to provide additional information regarding the real property asset to supplemental cost segregation study data not available to cost segregation system 102, and to generate a more accurate initial cost segregation template. In one or more of such embodiments, cost segregation system 102 incorporates additional cost segregation study data received from first electronic device 110 to generate the initial cost segregation template and provides the initial cost segregation template for display on first electronic device 110.

A user of electronic device 110, such as user 111, reviews the initial cost segregation template for the real property asset, updates the initial cost segregation template to include components actually included in the real property asset, and requests cost segregation system 102 to make corresponding updates to the initial cost segregation template of the real property asset. Continuing with the foregoing example, where user 111 updates the initial cost segregation template of the five-story office building to include actual components of the five-story office building. In some embodiments, where cost segregation system 102 is communicatively connected to multiple electronic devices, such as first and second electronic devices 110 and 120, cost segregation system 102 is operable to concurrently provide each electronic device with an initial cost segregation template, and dynamically or periodically update the initial cost segregation template and components of the real property asset of interest in response to updates provided by different electronic devices. For example, where cost segregation system 102 provides the initial cost segregation template of the five-story office building to first electronic device 110 and second electronic device 120, and where user 111 is updating components found on the first floor while user 121 is updating components found on the second floor, cost segregation system 102 is operable to simultaneously receive instructions from first electronic device 110 and second electronic device 120 to update the initial cost segregation template and components of the real property asset of interest, and provide first electronic device 110 and second electronic device 120 with up-to-date changes to the update the initial cost segregation template and components of the real property asset of interest. In one or more of such embodiments, cost segregation system 102 dynamically implements updates made by one electronic device (such as first electronic device 110) and updates the initial cost segregation template and components of the real property asset of interest across all of the electronic devices (such as second electronic device 120). In one or more of such embodiments, cost segregation system 102 also notifies each electronic device regarding changes or updates made by any of the electronic devices. Continuing with the foregoing example, where user 111 added ceiling fans installed throughout the first floor of the five-story office building, cost segregation system 102, in response to implementing the requested updates, notifies first and second electronic devices 110 and 120 about updates made by user 111.

Cost segregation system 102, after updating the initial cost segregation template of the real property of interest, determines cost segregation rules applicable to the plurality of components, and applies the cost segregation rules to determine cost segregation of the real property asset. In some embodiments, applicable cost segregation rules are based on the type and current state of the real property asset, the components of the real property asset, applicable laws and incentives, user-designated criteria, and other applicable criteria. Additional descriptions of operations performed by cost segregation system 102 to determine which applicable cost segregation rules are provided herein and are illustrated in at least FIG. 2.

Cost segregation system 102 generates one or more engineering reports of the cost segregation of the real property asset, and provides the engineering report for display on electronic devices, just as first electronic device 110 and second electronic device 120. In some embodiments, the generated engineering reports are customized reports that applies one or more user-designated methods, such as, but not limited to, partial asset disposition method, repair & maintenance method, normal real property depreciation method, as well as other applicable methods to determine depreciation of the real property asset of interest. In one or more of such embodiments, cost segregation system 102 forms a different engineering sub-report for each method of depreciation utilized to determine depreciation of the real property and organizes the engineering sub-reports within an overall engineering report. In one or more of such embodiments, cost segregation system 102 compares and contrasts depreciation of each component of the real property asset under different depreciation methods as well as tax savings under the different depreciation methods. In some embodiments, cost segregation system 102 classifies different components of the real property asset of interest into multiple classes, generates a sub-report of the cost segregation of each class, and organizes the engineering sub-reports within an overall engineering report. In some embodiments, cost segregation system 102 identifies and organizes the components of a real property asset into a number of unit of properties, generates a sub-report of the cost segregation of each unit of property, and organizes the engineering sub-reports within an overall engineering report. In some embodiments, cost segregation system 102 receives additional user-designated request (such as from users 111 or 121) to organize an engineering report, form engineering sub-reports, provide values associated with depreciation of the real property asset (such as the insurance replacement value of the real property asset), highlight differences between different depreciation methods, as well as other customizations of the engineering report. In one or more of such embodiments, cost segregation system 102 implements the user-designated request to organize or reorganize an engineering report, and provides the organized or reorganized engineering report for display on an electronic device of the user.

Network 106 can include, for example, any one or more of a cellular network, a satellite network, a personal area network (PAN), a local area network (LAN), a wide area network (WAN), a broadband network (BBN), an RFID network, a Bluetooth network, a device-to-device network, the Internet, and the like. Further, network 106 can include, but is not limited to, any one or more of the following network topologies, including a bus network, a star network, a ring network, a mesh network, a star-bus network, a tree or hierarchical network, or similar network architecture. Network 106 may be implemented using different protocols of the internet protocol suite such as TCP/IP. Network 106 includes one or more interfaces for data transfer. In some embodiments, network 106 includes a wired or wireless networking device (not shown) operable to facilitate one or more types of wired and wireless communication between cost segregation system 102, first electronic device 110, second electronic device 120, third-party system 130, as well as other electronic devices (not shown) and systems (not shown) communicatively connected to network 106. Examples of the networking device include, but are not limited to, wired and wireless routers, wired and wireless modems, access points, as well as other types of suitable networking devices described herein. Examples of wired and wireless communication include Ethernet, WiFi, Cellular, LTE, GPS, Bluetooth, and RFID, as well as other types of communication modes described herein.

Although FIG. 1 illustrates first electronic device 110 operated by user 111 and second electronic device 120 operated by user 121, in some embodiments, cost segregation system 102 concurrently or periodically receives multiple requests to perform one or more cost segregation studies on one or more real property assets from a different number of users. In some embodiments, cost segregation system 102 is configured to simultaneously perform operations described herein to perform cost segregation studies on multiple real property assets and generate engineering reports of the cost segregation of the real property assets, and provide the generated engineering reports to electronic devices of the users. As such, cost segregation system 102 is both configured to facilitate multiple users to perform a cost segregation study on a single real property asset, thereby reducing the overall time spent on performing the cost segregation study on the real property asset, and to facilitate multiple users to perform multiple cost segregation studies on different real property assets, thereby increasing the total number of cost segregation studies performed.

FIG. 2 is a tree diagram illustrating a process 200 to determine applicable cost segregation rules in accordance with one embodiment. Although operations in the process 200 are shown in a particular sequence, certain operations may be performed in different sequences or at the same time where feasible. Further, in some embodiments, different combinations of some or all of the steps of the process 200 are performed to select the therapeutic support surface.

At block 205, cost segregation system 102, upon receiving a request to perform a cost segregation study of a real property asset, accesses storage medium 104 to obtain instructions that define how to determine applicable cost segregation rules. In the depicted embodiment, instructions that define how to determine applicable cost segregation rules are categorized by several factors, including type and current state of a real property asset, components of the real property asset, applicable laws and incentives, and user-designated criteria.

At block 210, cost segregation system 102 accesses a first category of instructions that define how to determine applicable cost segregation rules based on the type and current state of the real property asset. In the depicted embodiment, the first category of instructions is further sub-divided into sub-categories of instructions, each defining how to determine applicable cost segregation rules based on different aspects of the type and current state of the real property asset. More particularly, at blocks 212, 214, 216, 218, and 219, cost segregation system 102 applies instructions that define how to determine applicable cost segregation rules based on whether the real estate asset is a residential real estate asset, whether the real estate asset is a commercial real estate asset, the age of the real property asset, the physical condition of the real property asset, and improvements made to the real property asset, respectively.

At block 230, cost segregation system 102 accesses a second category of instructions that define how to determine applicable cost segregation rules based on components of the real property asset. At block 232, cost segregation system 102 applies instructions that define how to determine applicable cost segregation rules based on the condition of the components. For example, cost segregation system 102 is configured to determine the condition of a component (such as a HVAC system) of a real property asset, determine the useful life of the component based on the condition of the component, and determine cost segregation rules based on the useful life of the component. At block 234, cost segregation system 102 applies instructions that define how to determine applicable cost segregation rules based on the class live of a component. At block 236, cost segregation system 102 applies instructions that define how to determine applicable cost segregation rules based on which unit of property different components of the real property asset are classified under. For example, cost segregation system 102 applies a first set of cost segregation rules for components classified as components of electrical systems (one unit of property), a second set of cost segregation rules for components classified as components of plumbing systems (second unit of property), and a third set of cost segregation rules for components classified as components of security systems (third unit of property).

At block 250, cost segregation system 102 accesses a third category of instructions that define how to determine applicable cost segregation rules based on applicable laws and incentives. At blocks 252, 254, 256, and 258, cost segregation system 102 applies instructions that define how to determine applicable cost segregation rules based on federal tax laws, federal tax incentives, state and local laws, and state and local incentives, respectively. In one or more of such embodiments, cost segregation system 102 periodically or dynamically queries systems and networks of tax agencies such as the Internal Revenue Services and tax preparation entities to obtain up-to-date federal, state, and local tax laws and tax incentives.

At block 270, cost segregation system 102 accesses a fourth category of instructions that define how to determine applicable cost segregation rules based on user-designated criteria. At blocks 272 and 274, cost segregation system 102 applies instructions that define how to determine applicable cost segregation rules based on user-designated cost segregation approach and user-designated depreciation approach, respectively. For example, where the user requests costs segregation system 102 to apply a partial asset disposition approach to determine cost segregation of the real property asset, cost segregation system 102 will apply rules that govern taking a partial asset disposition to determine cost segregation of the real property asset.

In certain embodiments, where some instructions are incompatible with other instructions, cost segregation system 102 applies a weighted system on different instructions for determining applicable cost segregation rules. For example, instructions to determine cost segregation rules based on current federal tax guidelines are given a first weight, instructions to determine applicable cost segregation rules based on a user-designated criteria are given a second weight that is less than the first weight, and instructions to determine cost segregation rules based on the age of the real property asset are given a third weight that is less than the second weight.

Although the foregoing paragraphs describe four categories of instructions that define how to determine applicable cost segregation rules, the instructions may be organized into a different number of categories. Further, in some embodiments, where multiple instructions that define how to determine applicable cost segregation rules are applicable, cost segregation system 102 is operable to apply each applicable instruction and to determine applicable cost segregation rules based on all applicable instructions. Further, cost segregation system 102 is operable to execute the instructions described in the foregoing paragraph to simultaneously determine multiple sets of cost segregation rules used to perform separate cost segregation studies on different real property assets.

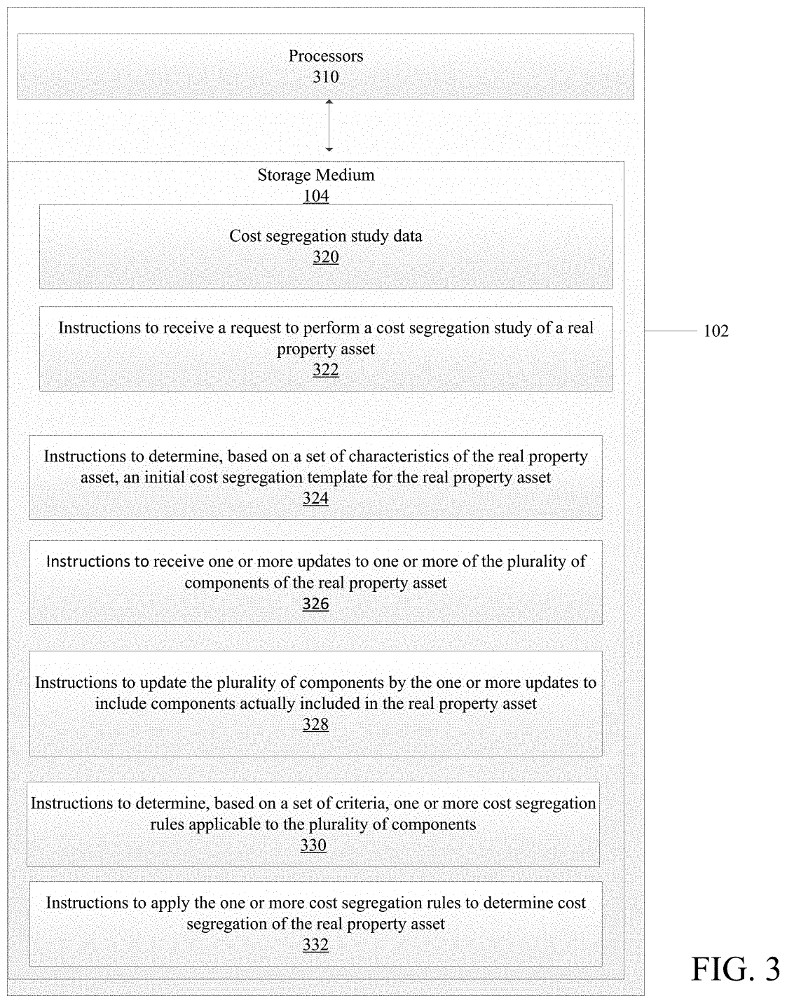

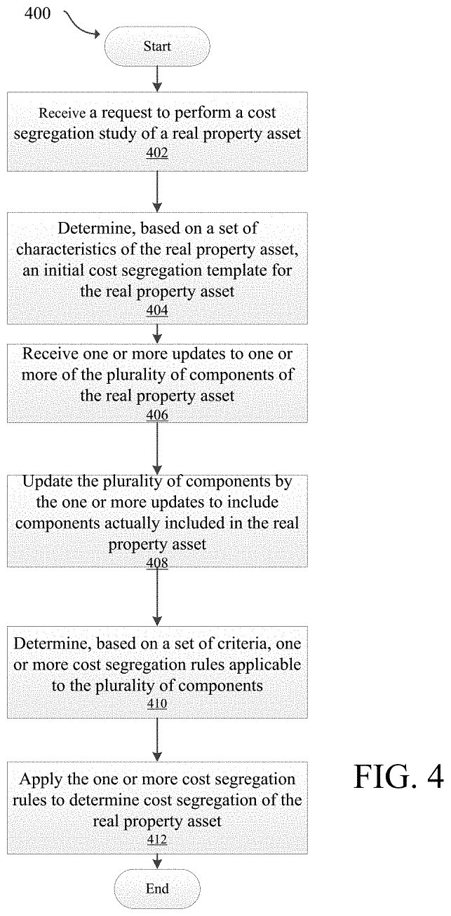

FIG. 3 is a system diagram of cost segregation system 102 of FIG. 1 in accordance with one embodiment. Cost segregation system 102 includes or is communicatively connected to storage medium 104 and processors 310. Cost segregation study data are stored at location 320 of storage medium 104. Instructions to receive a request to perform a cost segregation study of a real property asset are stored at location 322. Further, instructions to determine, based on a set of characteristics of the real property asset, an initial cost segregation template for the real property asset are stored at location 324. Further, instructions to receive one or more updates to one or more of the plurality of components of the real property asset are stored at location 326. Further, instructions to update the plurality of components by the one or more updates to include components actually included in the real property asset are stored at location 328. Further, instructions to determine, based on a set of criteria, one or more cost segregation rules applicable to the plurality of components are stored at location 330. Further, instructions to apply the one or more cost segregation rules to determine cost segregation of the real property asset are stored at location 332. Further, instructions to perform operations described herein and shown in at least FIGS. 2 and 4 are also stored in storage medium 104.

FIG. 4 is a flow chart illustrating a process 400 to perform a cost segregation study in accordance with one embodiment. Although the operations in process 400 are shown in a particular sequence, certain operations may be performed in different sequences or at the same time where feasible. Further, although process 400 is described to be performed by processors of cost segregation system 102 of FIG. 1, it is understood that processors of other cost segregation systems are also operable to perform process 400.

At block 402, a cost segregation system, such as cost segregation system 102 of FIG. 1 receives a request to perform a cost segregation study of a real property asset. FIG. 1, for example, illustrates cost segregation system 102 receiving a request from first electronic device 110 to perform a cost segregation study on a real property asset of interest. At block 404, the cost segregation system, in response to receiving the request, determines, based on a set of characteristics of the real property asset, an initial cost segregation template for the real property asset. As described herein, the initial cost segregation template is a template containing a plurality of components that qualifies for cost segregation and are predetermined to be included in the real property asset. In the embodiment of FIG. 1, cost segregation system 102 obtains cost segregation data associated with the real property asset of interest from storage medium 104, third-party system 130, and/or first and second electronic devices 110 and 120, generates an initial cost segregation template of the real property asset, and provides the initial cost segregation template of the real property asset for display on first and second electronic devices 110 and 120.

At block 406, the cost segregation system receives one or more updates to one or more of components of the real property asset. In the embodiment of FIG. 1, users 111 and 121 of first and second electronic devices 110 and 120 review the initial cost segregation template of the real property asset, customizes or updates the initial cost segregation template of the real property asset to include components actually included in the real property asset, where the updates are transmitted from first and second electronic devices 110 and 120 to cost segregation system 102. In some embodiments, first and second electronic devices 110 and 120 simultaneously transmit different updates to cost segregation system 102.

At block 408, the cost segregation system updates the components by the one or more updates to include components actually included in the real property asset. At block 410, the cost segregation system determines, based on a set of criteria, one or more cost segregation rules applicable to the components of the real property asset. FIG. 2, for example, illustrates a tree diagram illustrating a process 200 to determine applicable cost segregation rules in accordance based on categories and instructions described herein. At block 412 the cost segregation system applies the one or more cost segregation rules to determine cost segregation of the real property asset. In the embodiment of FIG. 1, cost segregation system 102 also generates an engineering report of the cost segregation of the real property and transmits the generated engineering report for display on first and second electronic devices 110 and 120, respectively.

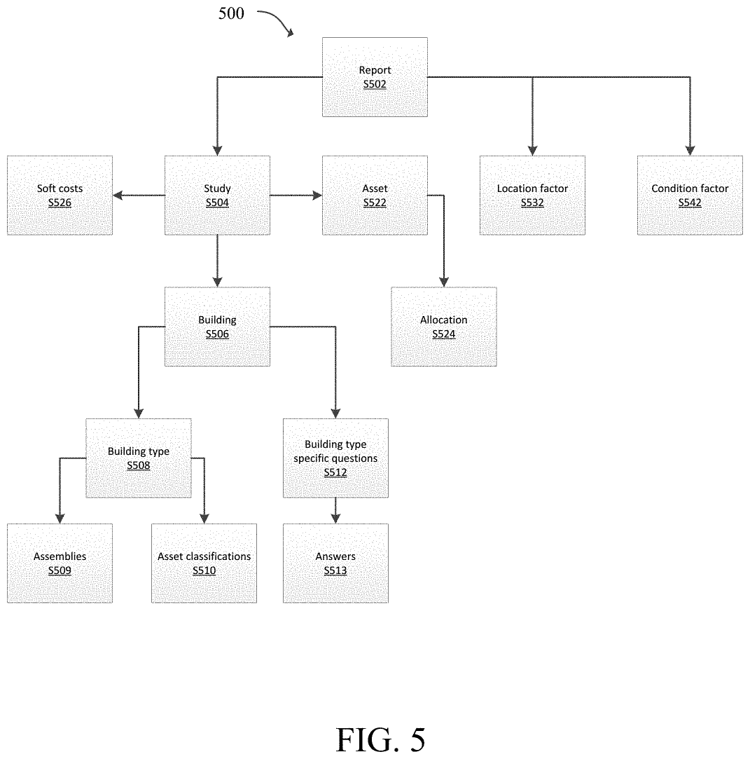

FIG. 5 is a flow chart illustrating a process 500 to perform a cost segregation study in accordance with one embodiment. Although the operations in process 500 are shown in a particular sequence, certain operations may be performed in different sequences or at the same time where feasible. Further, although process 500 is described to be performed by processors of cost segregation system 102 of FIG. 1, it is understood that processors of other cost segregation systems are also operable to perform process 500.

At block S502, a cost segregation system, such as cost segregation system 102 of FIG. 1, generates a report. In some embodiments, the report includes general information about a real property asset and a client of the real property asset. At block S504, the cost segregation system generates a study of one or more buildings. At block S506, the cost segregation system initiates a building generator operation to generate one or more buildings of the real property asset. At block S508, the cost segregation system analyzes the building type of a building. At blocks S509 and S510, respectively, the cost segregation system determines the typical assemblies of the building and the typical asset classifications of the building. Further, the cost segregation system concurrently or sequentially proceeds to block S512. At block S512, the cost segregation system determines building type specific questions of the building. At block S513, the cost segregation system determines user responses to one or more building type specific questions of the building. In some embodiments, the cost segregation system also determines additional information regarding the building and components of the building, including, but not limited to, the class lives of the components of the building, the item categories of the components of the building, the markup tags of the components of the building, the assemblies of the components of the building, and materials that form the components of the building. In some embodiments, the cost segregation data is configured to determine the cost of each base material of the real estate asset. In one or more of such embodiments, the cost segregation system determines the base material cost of a base material based on the RSmeans data associated with the base material, the condition of the base material (at block S542), the location of the base material (at block S532), soft costs associated with the base material (at block S526), and a basis allocation of the base material. In some embodiments, the cost segregation system performs operations described in blocks S508-S510, S512, and S513 for each building of one or more building of the real property asset.

At block S522, the cost segregation system determines the types of assets associated with the study. At block S524, the cost segregation system determinations the allocations of each asset, such as the dollar amount for each asset based on the class life of the asset. In some embodiments, the cost segregation system also determines credits and savings obtainable for each asset. At block S526, the cost segregation system determines soft costs of the real estate property. Examples of soft costs include, but are not limited to, permit fees, cleaning fees, and dumpster usage fees.

At block S532, the cost segregation system determines one or more location factors associated with the real estate asset. Examples of location factors include, but are not limited to, cost of labor, cost of materials, and applicable laws of a particular location. At block S542, the cost segregation system determines one or more condition factors of the real estate asset. Examples of condition factors include, but are not limited to, the age of the real estate asset, time since prior renovation, lifespan of the components of the real estate asset, and replacement period of the components.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

As used herein, the singular forms “a,” “an,” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A computer-implemented method to perform a cost segregation study of a real property asset, comprising:
receiving a request to perform a cost segregation study of a real property asset;
in response to receiving the request, determining, based on a set of characteristics of the real property asset, an initial cost segregation template for the real property asset, the initial cost segregation template being a template containing a plurality of components that qualify for cost segregation and are predetermined to be included in the real property asset;
receiving one or more updates to one or more of the plurality of components of the real property asset;
updating, in response to receiving the one or more updates, the plurality of components by the one or more updates to include components actually included in the real property asset;
determining, based on a set of criteria, one or more cost segregation rules applicable to the plurality of components; and
applying the one or more cost segregation rules to determine cost segregation of the real property asset.

2. The computer-implemented method of claim 1, further comprising:
generating an engineering report of the cost segregation of the real property asset; and
providing the engineering report for display on an electronic device.

3. The computer-implemented method of claim 2, further comprising:
determining an insurance replacement value of the real property asset,
wherein the engineering report comprises the insurance replacement value of the real property asset.

4. The computer-implemented method of claim 2, further comprising:
classifying the plurality of components into a plurality of classes; and
generating a plurality of engineering sub-reports of the cost segregation of the plurality of classes, wherein each sub-report corresponds to the cost segregation of a class of the plurality of classes,
wherein the engineering report comprises the plurality of engineering sub-reports.

5. The computer-implemented method of claim 2, further comprising:
applying different sets of cost segregation rules of the one or more cost segregation rules to determine different cost segregations of the real property asset based on the different sets of cost segregation rules; and
generating a plurality of engineering sub-reports of the cost segregation of the real property asset, wherein each sub-report corresponds to a cost segregation of real property asset based on a set of the different sets of the cost segregation rules,
wherein the engineering report comprises the plurality of engineering sub-reports.

6. The computer-implemented method of claim 2, further comprising:
determining a number of unit of properties of the real property asset; and
generating a plurality of engineering sub-reports of the cost segregation of the unit of properties, wherein each sub-report corresponds to the cost segregation of a different unit of property of the unit of properties of the real property asset,
wherein the engineering report comprises the plurality of engineering sub-reports.

7. The computer-implemented method of claim 1, further comprising:
providing the initial cost segregation template for display on an electronic device of an operator,
wherein the one or more updates to the one or more of the plurality of components of the real property asset are provided by the operator via the electronic device.

8. The computer-implemented method of claim 1, further comprising applying the one or more cost segregation rules to determine a depreciable basis of the real property asset.

9. The computer-implemented method of claim 1, further comprising determining a class life of a component of the plurality of components, wherein the class life of the component is a criterion of the set of criteria utilized to determine the one or more cost segregation rules.

10. The computer-implemented method of claim 1, further comprising determining an applicable law for determining cost segregation of the real property asset, wherein the applicable law is a criterion of the set of criteria utilized to determine the one or more cost segregation rules.

11. The computer-implemented method of claim 1, further comprising determining a location of the real property asset, wherein the location of the real property asset is a criterion of the set of criteria utilized to determine the one or more cost segregation rules.

12. The computer-implemented method of claim 1, further comprising determining an applicable tax incentive, wherein the one or more cost segregation rules comprises a rule that applies the applicable tax incentive.

13. The computer-implemented method of claim 1, further comprising after updating the plurality of components by the one or more updates, storing the initial cost segregation template containing the one or more updates as a new cost segregation template.

14. The computer-implemented method of claim 1, further comprising:
receiving a second request to perform a second cost segregation study of a second real property asset;
in response to receiving the second request, determining, based on a set of characteristics of the second real property asset, a second initial cost segregation template for the second real property asset, the second initial cost segregation template being a template containing a second plurality of components that qualify for cost segregation and are predetermined to be included in the second real property asset;
receiving one or more updates to one or more of the second plurality of components of the second real property asset;
updating, in response to receiving the one or more updates, the second plurality of components by the one or more updates to include components actually included in the second real property asset;
determining, based on a second set of criteria, one or more cost segregation rules applicable to the second plurality of components; and
applying the one or more cost segregation rules applicable to the second plurality of components to determine cost segregation of the second real property asset;
generating a first engineering report of the cost segregation of the real property asset; and
generating a second engineering report of the cost segregation of the second real property asset.

15. A cost segregation system, comprising:
a storage medium; and
one or more processors configured to:
receive a request to perform a cost segregation study of a real property asset;
in response to receiving the request, determine, based on a set of characteristics of the real property asset, an initial cost segregation template for the real property asset, the initial cost segregation template being a template containing a plurality of components that qualify for cost segregation and are predetermined to be included in the real property asset;
receive one or more updates to one or more of the plurality of components of the real property asset;
update, in response to receiving the one or more updates, the plurality of components by the one or more updates to include components actually included in the real property asset;
determine, based on a set of criteria, one or more cost segregation rules applicable to the plurality of components;
apply the one or more cost segregation rules to determine cost segregation of the real property asset;
generate an engineering report of the cost segregation of the real property asset; and
provide the engineering report for display on an electronic device.

16. The cost segregation system of claim 15, wherein the one or more processors are further configured to determine an insurance replacement value of the real property asset, wherein the engineering report comprises the insurance replacement value of the real property asset.

17. The cost segregation system of claim 15, wherein the one or more processors are further configured to:
classify the plurality of components into a plurality of classes; and
generate a plurality of engineering sub-reports of the cost segregation of the plurality of classes, wherein each sub-report corresponds to the cost segregation of a class of the plurality of classes,
wherein the engineering report comprises the plurality of engineering sub-reports.

18. The cost segregation system of claim 15, wherein the one or more processors are further configured to:
apply different sets of cost segregation rules of the one or more cost segregation rules to determine different cost segregations of the real property asset based on the different sets of cost segregation rules; and
generate a plurality of engineering sub-reports of the cost segregation of the real property asset, wherein each sub-report corresponds to a cost segregation of real property asset based on a set of the different sets of the cost segregation rules,
wherein the engineering report comprises the plurality of engineering sub-reports.

19. The cost segregation system of claim 15, wherein the one or more processors are further configured to:
receive a second request to perform a second cost segregation study of a second real property asset;
in response to receiving the second request, determining, based on a set of characteristics of the second real property asset, a second initial cost segregation template for the second real property asset, the second initial cost segregation template being a template containing a second plurality of components that qualify for cost segregation and are predetermined to be included in the second real property asset;
receive one or more updates to one or more of the second plurality of components of the second real property asset;
update, in response to receiving the one or more updates, the second plurality of components by the one or more updates to include components actually included in the second real property asset;
determine, based on a second set of criteria, one or more cost segregation rules applicable to the second plurality of components; and
apply the one or more cost segregation rules applicable to the second plurality of components to determine cost segregation of the second real property asset; and
generate a second engineering report of the cost segregation of the second real property asset.

20. A non-transitory computer readable storage medium having one or more instructions which, when executed by a processor, cause the processor to perform operations comprising:
receiving a request to perform a cost segregation study of a real property asset;
in response to receiving the request, determining, based on a set of characteristics of the real property asset, an initial cost segregation template for the real property asset, the initial cost segregation template being a template containing a plurality of components that qualify for cost segregation and are predetermined to be included in the real property asset;
providing the initial cost segregation template for display on an electronic device of an operator;
receiving one or more updates to one or more of the plurality of components of the real property asset, wherein the one or more updates to the one or more of the plurality of components of the real property asset are provided by the operator via the electronic device;
updating, in response to receiving the one or more updates, the plurality of components by the one or more updates to include components actually included in the real property asset;
determining, based on a set of criteria, one or more cost segregation rules applicable to the plurality of components;
applying the one or more cost segregation rules to determine cost segregation of the real property asset;
generating an engineering report of the cost segregation of the real property asset; and
providing the engineering report for display on the electronic device.
